(19) United States
(12) Patent Application Publication
(10) Pub. No.: US 2005/0039193 A1
(43) Pub. Date: Feb. 17, 2005

(54) Method and apparatus for generating device driver and user interface screen

(75) Inventors: In-sung Choi, Seoul (KR); Jae-kyoo Kang, Gyeonggi-do (KR); Hyung-jong Kang, Seoul (KR); Young-dal Oh, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/803,122

(22) Filed: Mar. 18, 2004

(30) Foreign Application Priority Data
Mar. 20, 2003 (KR) 2003-17386
Mar. 28, 2003 (KR) 2003-19680
May 23, 2003 (KR) 2003-32880

(51) Int. Cl. G06F 9/445; G06F 3/00; G06F 15/00; G06F 13/00

(52) U.S. Cl. 719/321; 719/327; 710/16; 715/700; 358/1.15; 717/174

(57) ABSTRACT

A method and apparatus generating a device driver and a user interface screen for the device driver. The method of generating a device driver having a plurality of functional components includes generating a file for each functional component of a device driver and a user interface; when a modification of a functional component is needed, rebuilding only a file corresponding to the functional component to be modified to make a device driver installation program; and reconstructing device driver information using a file corresponding to a functional component selected by a user on the device driver installation program and generating a device driver using the reconstructed device driver information.

### CROSS-REFERENCE TO RELATED APPLICATIONS

This application claims the priority of Korean Patent Applications No. 2003-17386, filed on Mar. 20, 2003, No. 2003-19680, filed on Mar. 28, 2003, and No. 2003-32880, filed on May 23, 2003, in the Korean Intellectual Property Office, the disclosures of which are incorporated herein by reference.

### BACKGROUND OF THE INVENTION

1. Field of the Invention

The present invention relates to a device driver, and more particularly, to a method and apparatus generating a device driver and a user interface screen.

2. Description of the Related Art

Conventionally, a device driver, for example, a printer driver, is generated using a driver file including all of the functions of the printer driver and a file for a user interface displaying the configuration of the printer driver to a user. The printer driver is generated in a personal computer using these two types of files, and a printer icon is generated using the generated printer driver. Thereafter, when the user selects the printer icon, a printing job is performed using the printer driver corresponding to the selected printer icon.

When users install and use printer drivers, they do not very frequently select various additional functions such as a watermark function, an overlay function, and a poster function besides basic functions. However, developers are required to provide all of the available functions for printer drivers. In addition, users should be able to have the option to select functions according to their needs.

However, conventional methods of generating a device driver, e.g., a printer driver, are disadvantageous in that a user is not allowed to selectively change only desired functions when installing the printer driver. This is because all of the functions of a printer driver are included in a single file when a printer driver or a user interface is developed for a particular model. In other words, in order to change a desired function, an entire driver is rebuilt, a driver installation program using the rebuilt driver is made, and I the driver is installed when a user clicks on the driver installation program.

In addition, when even a single function of a device driver, e.g., a printer driver, is to be changed according to conventional methods, a developer must rebuild an entire program including a source program of the changed function and source programs of the remaining unchanged functions. Accordingly, the conventional methods of generating a printer driver with a changed function have problems of increasing the amount of time taken to develop a printer driver and causing side effects.

In the meantime, when driving a peripheral device, a host displays a user interface screen to a user. User interface screens are different depending on the manufacturer of peripheral devices or product models even if the same manufacturer makes the peripheral devices. For example, the content of a menu displayed on a user interface screen changes according to models of peripheral devices. Accordingly, a host configures and compiles a user interface to be suitable to the model of a peripheral device to make a user interface file. The user interface file opens in connection with a driver file. Accordingly, a user can set various options and additional functions and change configuration values through the user interface screen that is opened by the user interface file.

Consequently, according to conventional methods of generating a user interface screen, when adding or deleting an item to the menu of a user interface screen, it is necessary to re-compile a user interface dynamic linking library (DLL) file to prepare a user interface screen for each model.

Moreover, according to conventional methods of generating a user interface screen, device driver manufacturers need to make separate user interface files for individual device models to generate user interface screens including different functions according to device models. Accordingly, a long period of time is needed to develop a device driver. In addition, the conventional methods of generating a user interface screens are inconvenient because the methods require a user to install different user interface screens for different device models.

### SUMMARY OF THE INVENTION

The present invention provides a method and apparatus generating a device driver, by which a function to be included in the device driver and a user interface is partially added, modified, or deleted independent of the entire device driver and the result of the addition, modification, or deletion is reflected in the entire device driver.

The present invention also provides a method and apparatus generating a user interface screen for a device driver, by which a user interface screen having a different menu according to the model of a peripheral device is simply generated and displayed in real time using a particular information file without re-compiling a user interface dynamic linking library (DLL) file.

The present invention also provides a method and apparatus generating a user interface screen for a device driver, by which a user interface screen having a different menu according to the model of a peripheral device is simply generated and displayed using a common user interface screen and model dependent information.

According to an aspect of the present invention, there is provided a method of generating a device driver having a plurality of functional components. The method includes generating a file for each functional component of a device driver and a user interface; when a modification of a functional component is needed, rebuilding only a file corresponding to the functional component to be modified to make a device driver installation program; and reconstructing device driver information using the file corresponding to the functional component selected by a user on the device driver installation program and generating a device driver using the reconstructed device driver information.

Generating the file may include constructing each functional component according to a model and functions of a device and generating a file for each functional component.

According to another aspect of the present invention, there is provided an apparatus generating a device driver having a plurality of functional components. The apparatus includes an installation program maker which generates a file for each functional component of a device driver and a user interface and rebuilds only a file corresponding to a functional component to be modified to make a device driver installation program; and a driver generator which reconstructs information on the device driver to be installed using a file corresponding to a functional component selected by a user on the device driver installation program and generates a device driver using the reconstructed device driver information.

The device may be a printer, and each functional component may have a data structure value of a DEVice MODE (DEVMODE) as a parameter.

According to still another aspect of the present invention, there is provided a method of generating a user interface screen for a device driver. The method includes determining whether a particular information file including menu generation information for a user interface screen depending on a device model exists; extracting the menu generation information from the particular information file when the particular information file exists; and generating a user interface screen for the device driver based on the extracted menu generation information.

Determining may be performed when opening a user interface screen. The method may further include generating a user interface screen based on predetermined default values when the particular information file does not exist.

According to still another aspect of the present invention, there is provided an apparatus generating a user interface screen for a device driver. The apparatus includes a file detector which detects whether a particular information file including menu generation information for a user interface screen depending on a device model exists, a particular information extractor which extracts the menu generation information from the particular information file when the particular information file exists, and a screen generator which generates a user interface screen based on the extracted menu generation information.

The screen generator may generate a user interface screen based on predetermined default values when the particular information file does not exist.

According to still another aspect of the present invention, there is provided a method of generating a user interface screen for a device driver. The method includes installing a device driver and a user interface for the device driver in a host and requesting model dependent information from a device connected to the host; receiving the model dependent information and model identification information from the device and determining whether the device can be driven by the device driver based on the model dependent information; and when determined that the device can be driven by the device driver, generating a user interface screen for the device driver using the model dependent information of the device.

Generating the user interface screen may include storing the model dependent information when the device can be driven by the device driver, and generating the user interface screen using the model dependent information when generation of the user interface screen is requested. Storing the model dependent information may include requesting model dependent information from the device when the device can be driven by the device driver and a user requests an update of the model dependent information, and storing the model dependent information and the model identification information in the host.

According to still another aspect of the present invention, there is provided an apparatus generating a user interface screen for a device driver. The apparatus includes a driver dependent information requestor which requests model dependent information from a device connected to a host after a device driver and a user interface for the device driver is installed in the host, an information input unit which receives the model dependent information and model identification information from the device, a comparator which compares the model identification information with installed driver information, and a screen generator which generates a user interface screen using the model dependent information when the model identification information is the same as the installed driver information. Here, the installed driver information identifies a model of a device that can be driven by the installed device driver.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a flowchart of a method of generating a printer driver according to an embodiment of the present invention;

FIGS. 2A and 2B illustrate user interface screens explaining operation 18 shown in FIG. 1;

FIG. 3 is a block diagram of an apparatus generating a printer driver according to an embodiment of the present invention;

FIG. 4 is a flowchart of a method of generating a user interface screen according to an embodiment of the present invention;

FIG. 5 is a block diagram of an apparatus generating a user interface screen according to an embodiment of the present invention;

FIG. 6 illustrates an example of a user interface screen generated according to the embodiment of the present invention shown in FIG. 5;

FIG. 7 illustrates another example of a user interface screen generated according to the embodiment of the present invention shown in FIG. 5;

FIG. 8 is a flowchart of a method of generating a user interface screen according to another embodiment of the present invention;

FIG. 9 is a block diagram of an apparatus generating a user interface screen according to another embodiment of the present invention; and

FIG. 10 is a block diagram of a host and a device explaining an apparatus generating a user interface screen according to an embodiment of the present invention.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

Hereinafter, a method of generating a device driver according to an embodiment of the present invention will be described in detail with reference to the attached drawings. For clarity of the description, it is assumed that a printer is used as a device. Accordingly, a method and an apparatus of generating a printer driver according to embodiments of the present invention will be described.

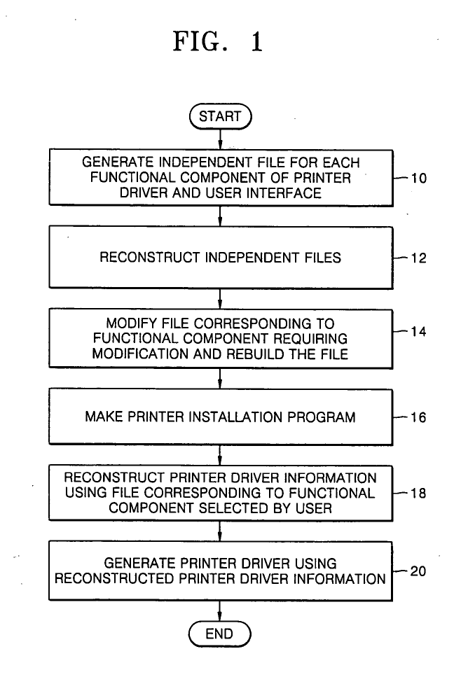

FIG. 1 is a flowchart of a method of generating a printer driver according to an embodiment of the present invention. The method includes making a printer driver installation program in operations 10 through 16 and generating a printer driver in operations 18 and 20.

When developing a printer driver having multiple functions and a user interface therefor, an independent file is generated for each functional component of the printer driver and the user interface in operation 10. The file for each functional component includes a unique function of the printer driver or the user interface.

After operation 10, each independent file is reconstructed to be suitable to an operating system (OS) of a computer in operation 12. Each functional component has a data structure value of a DEVice MODE (DEVMODE) as a parameter.

After operation 12, a file corresponding to a functional component needing a modification (including deletion and addition) is independently and individually modified and rebuilt in operation 14. Thereafter, a printer installation program is made in operation 16.

After operation 16, information on a printer driver to be installed is reconstructed in run-time to be suitable to a printer driver generation reference using a file corresponding to a functional component that is selected by a user during execution of a printer driver installation program in operation 18. Next, a printer driver is generated using the reconstructed printer driver information in operation 20.

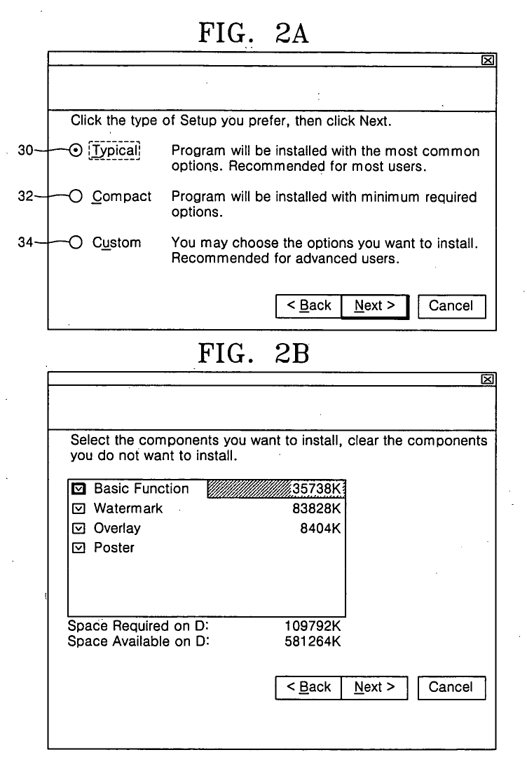

FIGS. 2A and 2B illustrate user interface screens explaining operation 18 shown in FIG. 1. FIG. 2A illustrates a user interface screen displaying function selection menus 30, 32, and 34, and FIG. 2B illustrates a user interface screen displayed to a user when the function selection menu 34 was selected. Referring to FIGS. 2A and 2B, the information on the printer driver to be installed is reconstructed using the file corresponding to the function selected by the user in the printer driver installation program in operation 18.

For example, the user interface screen shown in FIG. 2A is displayed to a user. When the user selects the function selection menu 30 named “Typical” shown in FIG. 2A, only typical functions are selected from among all the functions of a printer driver. When the user selects the function selection menu 32 named “Compact” shown in FIG. 2A, minimum functions such as copy and paper size are selected from among the functions of the printer driver. When the user selects the function selection menu 34 named “Custom” in FIG. 2A, the user can directly select desired functions from among the functions of the printer driver. When the user selects the function selection menu 34 shown in FIG. 2A, the user interface screen shown in FIG. 2B is displayed. As shown in FIG. 2B, the user can select all of the functions, i.e., a basic function, a watermark function, an overlay function, and a poster function. Thereafter, the printer driver having only functions selected by the user is generated using the reconstructed printer driver information in operation 20. At this time, a printer icon is generated in a personal computer. Thereafter, when the user clicks on the printer icon using a pointing device such as a mouse (not shown), a printing job can be performed.

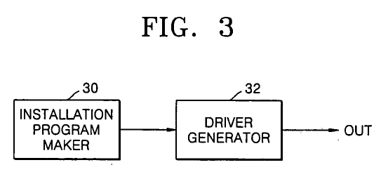

Hereinafter, the structure and operations of an apparatus generating a device driver, for example, a printer driver, will be described with reference to the attached drawings. FIG. 3 is a block diagram of an apparatus generating a printer driver according to an embodiment of the present invention. The apparatus includes an installation program maker 30 and a driver generator 32. The apparatus shown in FIG. 3 can perform the method shown in FIG. 1.

To perform operations 10 through 16 shown in FIG. 1, the installation program maker 30 generates a file for each functional component of the printer driver and the user interface. When a modification of a functional component is needed, the installation program maker 30 rebuilds only the file corresponding to the functional component to be modified and makes a printer driver installation program.

To perform operations 18 and 20, the driver generator 32 reconstructs information on the printer driver to be installed using a file corresponding to a function selected by a user in the printer driver installation program received from the installation program maker 30, and generates a printer driver using the reconstructed information.

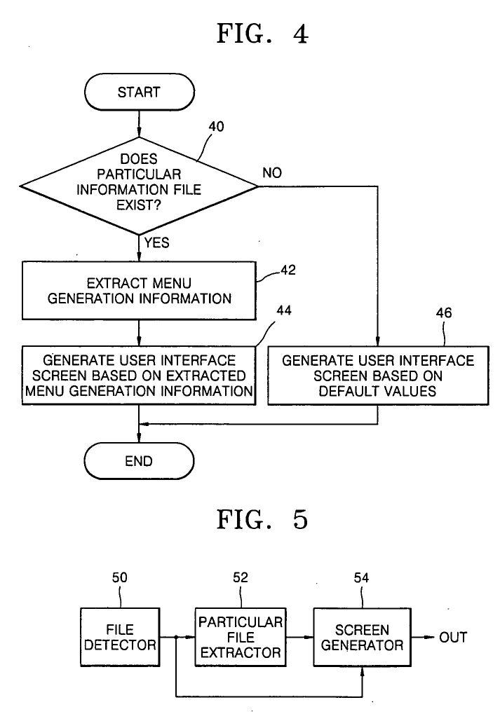

Hereinafter, a method of generating a user interface screen for a device driver according to an embodiment of the present invention will be described in detail with respect to the attached drawings. FIG. 4 is a flowchart of a method of generating a user interface screen according to an embodiment of the present invention. The method includes generating a user interface screen according to the existence or non-existence of a particular information file in operations 40 through 46.

Referring to FIG. 4, whether a particular information file exists is determined in operation 40. The particular information file stores menu generation information that is peculiar to each device model. The particular information file has a type of a configuration file which stores conditions or properties of a system configuration component selected by a user during installation of an application program. The menu generation information peculiar to each device model can be stored in the form of an entry table. Table 1 shows an example of the entry table.

TABLE 1

| Entries | Values |
|---|---|
| Double-sided printing | 1 |
| Reduction printing | 0 |
| . | . |
| . | . |
| . | . |

In this embodiment, a value of “1” in the entry table indicates that a corresponding menu item listed in the entries section should be displayed on a user interface screen. A value of “0” indicates that a corresponding menu item listed in the entries section should not be displayed on the user interface screen. In other words, when an entry of the double-sided printing has a value of “1” in Table 1, a menu item of the double-sided printing is displayed on the user interface screen. Operation 40 is performed to open the user interface screen.

If the particular information file exists, the menu generation information is extracted from the particular information file in operation 42. The values of the entries listed on the entry table correspond to the menu generation information.

Next, a user interface screen is generated based on the extracted menu generation information and a user interface dynamic linking library (DLL) file in operation 44. Only a menu item corresponding to the extracted menu generation information is added to a basic user interface screen. Conventionally, a user interface screen is generated by compiling the user interface DLL file. However, in the present invention, the user interface DLL file is modified using the extracted menu generation information. A DLL file is fundamentally provided in an OS such as OS/2 or WINDOWS and is used to divide a routine of software into multiple files in a disc and load only a necessary file in memory. The DLL is advantageous in sharing a routine. A set of functions of a routine is referred to as a library. When making an execution file, a compilation is usually made including the library. However, this method is ineffective because multiple execution files have the same routine. Because the DLL can be shared by multiple execution files, the disc capacity or memory can be reduced. In addition, a program may be modified by modifying only a DLL file. The OS such as WINDOWS may share the DLL with applications. A user is often unable to detect this sharing.

When the particular information file does not exist, a user interface screen is generated based on default values in operation 46. As described above, the user interface screen generated in operation 44 or 46 can be displayed to a user.

Hereinafter, the structure and operation of an apparatus generating a user interface screen according to an embodiment of the present invention will be described with reference to the attached drawings. FIG. 5 is a block diagram of an apparatus generating a user interface screen according to an embodiment of the present invention. The apparatus includes a file detector 50, a particular file extractor 52, and a screen generator 54.

The apparatus shown in FIG. 5 performs the method of generating a user interface screen shown in FIG. 4. To perform operation 40, the file detector 50 detects whether a particular information file exists and outputs a detection result as a control signal to the particular file extractor 52 and the screen generator 54.

To perform operation 42, the particular file extractor 52 extracts menu generation information from the particular information file in response to the control signal received from the file detector 50 and outputs the extracted menu generation information to the screen generator 54. For example, when recognizing that the particular information file exists based on the control signal, the particular file extractor 52 extracts the menu generation information from the particular information file.

To perform operation 44, the screen generator 54 generates a user interface screen based on the menu generation information received from the particular file extractor 52 in response to the control signal received from the file detector 50. For example, when recognizing that the particular information file exists, the screen generator 54 generates a user interface screen based on the menu generation information extracted by the particular file extractor 52. However, when recognizing that the particular information file does not exist, the screen generator 54 generates a user interface screen based on default values.

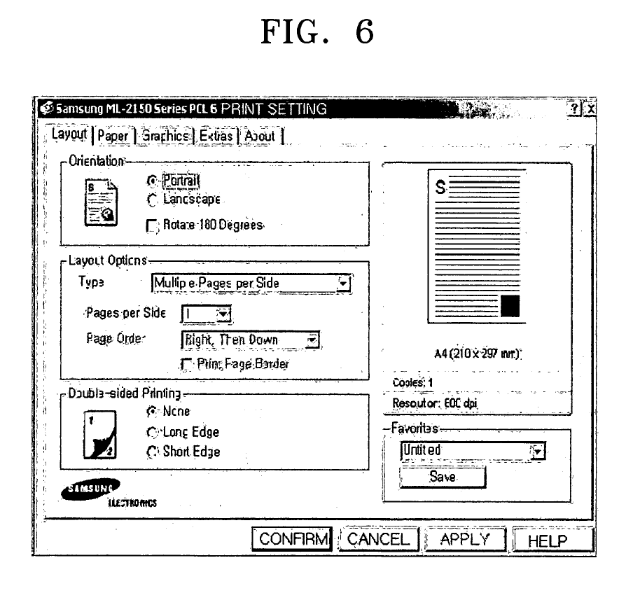

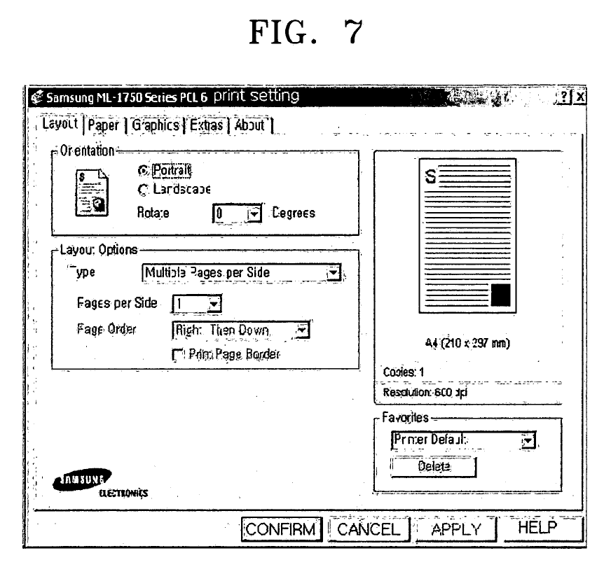

The apparatus for generating a user interface screen shown in FIG. 5 may be included in a host driving a device such as a peripheral device. FIGS. 6 and 7 illustrate examples of a user interface screen. Assuming that there are peripheral devices of two different models, i.e., a first model with a double-sided printing function and a second model without the double-sided printing function, then a user interface screen suitable for the peripheral device of the first model includes a “Double-sided Printing” menu item, as shown in FIG. 6. A user interface screen suitable to the peripheral device of the second model does not include the “Double-sided Printing” menu item, as shown in FIG. 7.

According to conventional methods of generating a user interface screen, both of the user interface screens shown in FIGS. 6 and 7 need to be provided in order to drive the first and second peripheral models. However, the present invention does not require both of the user interface screens shown in FIGS. 6 and 7. In other words, according to the present invention, information on double-sided printing is extracted from the particular information file, and the user interface screen shown in FIG. 6 is simply generated using the extracted information.

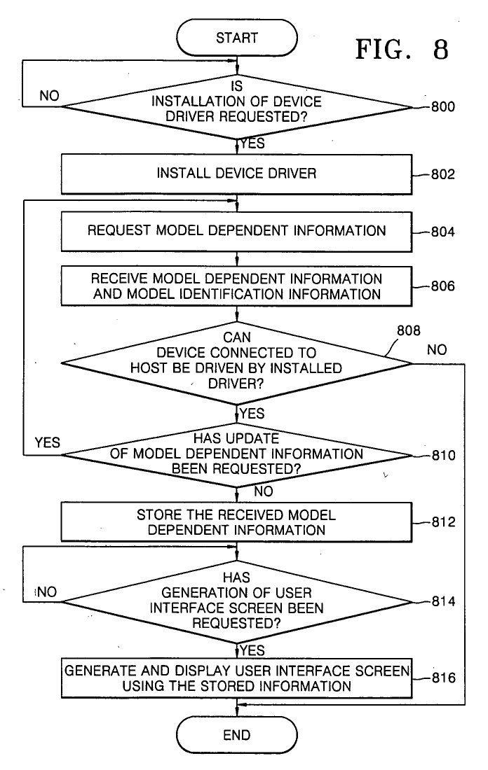

FIG. 8 is a flowchart of a method of generating a user interface screen according to another embodiment of the present invention. The method includes requesting and receiving model dependent information from a device after installing a driver in operations 800 through 806, and generating a user interface screen corresponding to the model dependent information when the device connected to a host can be driven by the installed driver in operations 808 through 816.

The method shown in FIG. 8 is performed by a host. The host installs a device driver and a user interface in operations 800 and 802 and requests model dependent information indicating a function peculiar to each model of a device from the device in operation 804.

More specifically, the host determines whether installation of a device driver is requested in operation 800. When installation of a device driver is not requested, operation 800 is repeated. However, when installation of a device driver is requested, the host installs a device driver in operation 802. When the device driver is installed, a user interface for the device driver is also installed. The user interface includes all of functions supported by all of the models of the device. After operation 802, the host requests model dependent information from the device in operation 804. The model dependent information may include a type of supporting function of the device connected to the host and/or a device set image. The supporting function may be a double-sided printing function, an N-up function, or a post function. The N-up function prints the data of multiple pages on a single sheet. The post function enlarges the data of a page in a horizontal and/or vertical direction. The device set image is an image expressing a structure, e.g., a paper cassette or tray, of the device.

After operation 804, the host receives the model dependent information and model identification information from the device in operation 806. The model identification information allows the host to identify the device connected thereto and may be a device identification (ID). After operation 806, the host determines whether a model of the device connected to the host can be driven by the installed driver using the model identification information in operation 808. In other words, the host determines whether the device ID received from the connected device is the same as an ID of a device that can be driven by the driver installed in operation 802.

When the model of the device connected to the host can be driven by the driver installed in operation 802, the host displays a user interface screen to a user based on the model dependent information received from the device in operations 810 through 816.

When the model of the device connected to the host can be driven by the driver installed in operation 802, it is determined whether the user has requested an update of the model dependent information in operation 810. When the user has requested an update of the model dependent information, the method returns to operation 804. However, when the user has not requested an update of the model dependent information, the received model dependent information is stored in operation 812.

In other embodiments of the present invention, a method of generating a user interface screen may not include operation 810. In this case, when it is determined that the model of the device connected to the host can be driven by the driver installed in operation 802, the received model dependent information is stored in operation 812. The model dependent information may be stored in a data file or a registry.

After operation 812, it is determined whether the user has requested generation of a user interface screen in operation 814. When the user has not requested generation of a user interface screen, operation 814 is repeated. However, when the user has requested generation of a user interface screen, the host changes an existing user interface file based on the model dependent information and generates and displays a user interface screen using the changed user interface file in operation 816. Here, the user interface screen shows functions supported by the device connected to the host to the user. Accordingly, the user can select a desired function on the user interface screen. The details of the set image included in the model dependent information may be displayed on the user interface screen. For example, when the device has two paper cassettes, an image expressing two paper cassettes may be displayed to the user on the user interface screen.

More specifically, when the device is a printer that can have at least two paper cassettes, the printer may embed an image expressing the total number of available paper cassettes into the model dependent information and send it to the host. Alternatively, the printer may check the number of currently installed paper cassettes, embed an image expressing the checked number of paper cassettes into the model dependent information, and send it to the host. In the former case, the host needs to check the number of currently installed paper cassettes. However, in the latter case, the host does not need to check the paper cassettes.

Hereinafter, the structure and operations of an apparatus generating a user interface screen according to another embodiment of the present invention will be described with reference to the attached drawings.

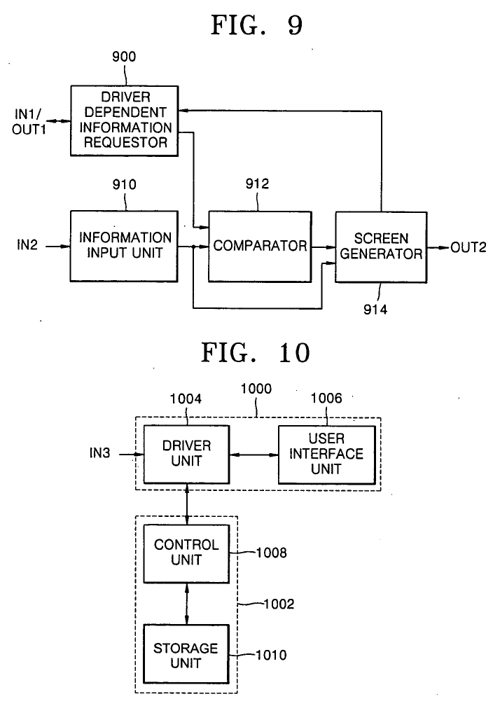

FIG. 9 is a block diagram of an apparatus generating a user interface screen according to another embodiment of the present invention. The apparatus includes a driver dependent information requestor 900, an information input unit 910, a comparator 912, and a screen generator 914. The apparatus shown in FIG. 9 can perform the method shown in FIG. 8.

To perform operations 800 through 804 shown in FIG. 8, the driver dependent information requestor 900 installs a device driver received through an input terminal IN1 when installation of the device driver is requested, and outputs an information request signal requesting model dependent information to the device through an output terminal OUT1. In other words, the driver dependent information requester 900 determines whether installation of the device driver is requested to perform operation 800, installs the device driver in response to a determination result to perform operation 802, and then requests the model dependent information from the device to perform operation 804. Then, the device connected to the apparatus shown in FIG. 9 transmits the model dependent information and its model identification information to the information input unit 910 in response to the information request signal received from the driver dependent information requestor 900.

To perform operation 806, the information input unit 910 receives the model dependent information and the model identification information from the device through an input terminal IN2. The information input unit 910 outputs the model dependent information to the screen generator 914 and outputs the model identification information to the comparator 912.

To perform operation 808, the comparator 912 compares the model identification information received from the information input unit 910 with the installed driver information received from the driver dependent information requestor 900 and outputs a comparison result as a control signal to the screen generator 914. For this operation, the driver dependent information requestor 900 generates the installed driver information and outputs it to the comparator 912.

To perform operations 810 through 816, in response to the control signal received from the comparator 912, the screen generator 914 generates a user interface screen based on the model dependent information received from the information input unit 910 and outputs the user interface screen through an output terminal OUT2 to display the user interface screen to a user. For example, to perform operation 810, the screen generator 914 determines whether the user has requested an update of the model dependent information in response to the control signal received from the comparator 912 and outputs a determination result to the driver dependent information requestor 900. Then, the driver dependent information requestor 900 requests model dependent information from the device when recognizing that the user has requested the update of the model dependent information.

However, if the user does not request an update of the model dependent information, the screen generator 914 stores the model dependent information received from the information input unit 910 to perform operation 812. Then, to perform operation 814, the screen generator 914 determines whether the user has requested generation of a user interface screen. When the user has requested generation of the user interface screen, to perform operation 816, the screen generator 914 generates a user interface file based on the stored model dependent information, generates a user interface screen using the user interface file, and outputs the user interface screen through the output terminal OUT2 to show the user interface screen to the user.

Hereinafter, the structure and operations of a host including an apparatus generating a user interface screen according to an embodiment of the present invention and the structure and the operations of a device connected to the host will be described with reference to the attached drawings. FIG. 10 is a block diagram of a host 1000 and a device 1002 explaining an apparatus generating a user interface screen according to an embodiment of the present invention.

The host 1000 includes a driver unit 1004 and a user interface unit 1006. Assuming that the driver unit 1004 includes the driver dependent information requestor 900, the information input unit 910, and the comparator 912 shown in FIG. 9 and the user interface 1006 includes the screen generator 914 shown in FIG. 9. In this situation, the driver unit 1004 installs a driver input through input terminal IN3, requests model dependent information from the device 1002, and receives the model dependent information from the device 1002. Next, the driver unit 1004 determines whether the installed driver can drive the device 1002.

When the driver unit 1004 determines that the device 1002 can be driven by the installed driver and an update of the model dependent information has not been requested, the user interface unit 1006 stores the model dependent information. Thereafter, when generation of a user interface screen is requested, the user interface unit 1006 generates the user interface screen based on the model dependent information and displays the user interface screen to the user. The user interface unit 1006 informs the driver unit 1004 whether the update of the model dependent information has been requested, and the driver unit 1004 requests model dependent information from the device 1002 when the update of the model dependent information has been requested.

For the above-described operations, the device 1002 includes a control unit 1008 and a storage unit 1010. The storage unit 1010 stores the model dependent information. When the driver unit 1004 requests the model dependent information, the control unit 1008 reads the model dependent information from the storage unit 1010 and outputs the model dependent information and model identification information to the driver unit 1004.

In a method and apparatus generating a device driver according to the present invention, a user is allowed to directly select only a functional component to be modified from among all of the functional components of a device driver through a user interface, the selected functional component can be independently modified, and a modified result can be reflected onto the entire device driver. Accordingly, the user can flexibly install and use a printer driver.

In addition, because an entire device driver can be constructed by selectively combining only the functions necessary for each model of a device when the device driver is developed, managing a new program source of each model is not necessary. As a result, development time and loss can be reduced. Because a particular function can be independently modified without influencing other functions, side effects can be decreased. Moreover, because the device driver can be reused, a printer driver can be efficiently developed and used.

In a method and apparatus generating a user interface screen according to an embodiment of the present invention, a user interface screen including a desired menu can be easily generated in real time by reflecting information extracted from a particular information file to a single DLL file without recompiling a necessary DLL file. In addition, because a host does not need to have a plurality of user interface screens for different models, a load on the host is decreased, and therefore, a user interface screen can be modified simply.

In a method and apparatus generating a user interface screen according to another embodiment of the present invention, a desired user interface screen can be generated by modifying a common user interface screen based on model dependent information provided by a device, thereby reducing development time and eliminating the inconvenience of newly installing a driver every time a device is changed.

The present invention can be embodied as a computer readable code in a computer readable medium. Here, the computer readable medium may be any recording apparatus capable of storing data that is read by a computer system, e.g., a read-only memory (ROM), a random access memory (RAM), a compact disc (CD)-ROM, a magnetic tape, a floppy disk, an optical data storage device, and so on. Also, the computer readable medium may be a carrier wave that transmits data via the Internet, for example. The computer readable recording medium can be distributed among computer systems that are interconnected through a network, and the present invention may be stored and implemented as a computer readable code in the distributed system.

Although a few embodiments of the present invention have been shown and described, it would be appreciated by those skilled in the art that changes may be made in this embodiment without departing from the principles and spirit of the invention, the scope of which is defined in the claims and their equivalents.

1. A method of generating a device driver having a plurality of functional components, the method comprising:
generating a file for each functional component of the device driver and a user interface;
rebuilding only a file corresponding to the functional component to be modified to make a device driver installation program when a modification of a functional component is needed; and
reconstructing the device driver information using a file corresponding to the functional component selected by a user on the device driver installation program and generating an update to the device driver using the reconstructed device driver information.

2. The method of claim 1, wherein the generating the file comprises constructing each functional component according to a model and functions of a device and generating the file for each functional component.

3. The method of claim 1, wherein the device driver is used in a printer, and each functional component has a data structure value of a DEVice MODE (DEVMODE) as a parameter.

4. An apparatus generating a device driver having a plurality of functional components, the apparatus comprising:
an installation program maker which generates a file for each functional component of the device driver and a user interface and rebuilds only the file corresponding to a functional component to be modified to make a device driver installation program; and
a driver generator which reconstructs information on the device driver to be installed using the file corresponding to the functional component selected by a user on the device driver installation program and generates an update to the device driver using the reconstructed device driver information.

5. The apparatus of claim 4, wherein the device driver is used in a printer, and each functional component has a data structure value of a DEVice MODE (DEVMODE) as a parameter.

6. A method of generating a user interface screen for a device driver, the method comprising:
determining whether a particular information file including menu generation information for the user interface screen depending on a device model exists;
when the particular information file exists, extracting the menu generation information from the particular information file; and
generating the user interface screen for the device driver based on the extracted menu generation information.

7. The method of claim 6, wherein the determining is performed when opening the user interface screen.

8. The method of claim 6, further comprising:
generating the user interface screen based on predetermined default values when the particular information file does not exist.

9. An apparatus generating a user interface screen for a device driver, the apparatus comprising:
a file detector which detects whether a particular information file including menu generation information for the user interface screen depending on a device model exists;
a particular information extractor which extracts the menu generation information from the particular information file when the particular information file exists; and
a screen generator which generates the user interface screen based on the extracted menu generation information.

10. The apparatus of claim 9, wherein the screen generator generates the user interface screen based on predetermined default values when the particular information file does not exist.

11. A method of generating a user interface screen for a device driver, the method comprising:
installing the device driver and the user interface screen for the device driver in a host and requesting model dependent information from a device connected to the host;
receiving the model dependent information and model identification information from the device and determining whether the device can be driven by the device driver based on the model dependent information; and
in response to the determining that the device can be driven by the device driver, generating the user interface screen for the device driver using the model dependent information of the device.

12. The method of claim 11, wherein the generating the user interface screen comprises:
storing the model dependent information when the device can be driven by the device driver; and
generating the user interface screen using the model dependent information when generation of the user interface screen is requested.

13. The method of claim 12, wherein the storing the model dependent information comprises:
requesting model dependent information from the device when the device can be driven by the device driver and a user requests an update of the model dependent information; and
storing the model dependent information and the model identification information in the host.

14. An apparatus generating a user interface screen for a device driver, the apparatus comprising:
a driver dependent information requestor which requests model dependent information from a device connected to a host after the device driver and the user interface screen for the device driver are installed in the host;
an information input unit which receives the model dependent information and model identification information from the device;
a comparator which compares the model identification information with installed driver information; and
a screen generator which generates the user interface screen using the model dependent information when the model identification information is the same as the installed driver information,
wherein the installed driver information identifies a model of a supported device that can be driven by the installed device driver.

15. A method of generating a device driver of a peripheral, comprising:
selecting a predetermined number of functional components of the device driver;
modifying the selected predetermined number of functional components of the device driver while leaving other functional components of the device driver unmodified; and
updating the device driver with the modified predetermined number of functional components.

16. The method of claim 15, further comprising:
generating a user interface based on information extracted from the updated device driver.

17. The method of claim 16, wherein the generating the user interface is done in real time.

18. The method of claim 16, wherein the generating the user interface comprises reflecting the information extracted to a single user interface DLL file.

19. The method of claim 16, wherein the generating the user interface comprises modifying the user interface based on a model of the peripheral.

20. The method of claim 15, further comprising:
requesting and receiving model dependent information from the peripheral; and
generating a user interface based on information extracted from the updated device driver and the received model dependent information when the peripheral is compatible with the updated device driver.

21. A device driver generating apparatus of a peripheral, comprising:
an installation programmer which generates separate files corresponding to respective functional components of a device driver and selectively modifies only a file corresponding to a functional component to be modified to generate a device driver installation program;
a driver generator which generates the device driver based on functional components selected by a user in the device driver installation program;
a particular file extractor which extracts menu generation information from one of an information file which stores menu generation information corresponding to different models of the peripheral, and a default information file which stores generic menu generation information; and
a screen generator which generates a user interface screen based on the extracted menu generation information.

22. The apparatus of claim 21, further comprising:
a file detector which selectively controls the particular file extractor to extract one of an information file which stores menu generation information corresponding to different models of the peripheral, and a default information file which stores generic menu generation information based on whether an information file including menu generation information for a user interface screen depending on a device model exists.

23. The apparatus of claim 21, wherein the screen generator further comprises:
a driver dependent information requester which requests model dependent information from the peripheral;
an information input unit which receives the model dependent information and model identification information from the peripheral in response to the request for model dependent information; and
a comparator which compares the model identification information with the device driver, wherein the user interface screen is based on the extracted menu generation information and the received model dependent information when the peripheral is compatible with the device driver.

24. The apparatus of claim 21, wherein the peripheral is a printer.

25. The apparatus of claim 24, wherein the each of the functional components has a device mode (DEVMODE) data structure value as a parameter.

26. A computer readable recording medium recording a program that executes a method of generating a device driver of a peripheral, wherein the method comprises:
selecting a predetermined number of functional components of the device driver;
modifying the selected predetermined number of functional components of the device driver while leaving other functional components of the device driver unmodified; and
updating the device driver with the modified predetermined number of functional components.

27. A computer readable recording medium recording a program that executes a method of generating a user interface screen for a device driver, wherein the method comprises:
installing a device driver and a user interface for the device driver in a host and requesting model dependent information from a device connected to the host;
receiving the model dependent information and model identification information from the device and determining whether the device can be driven by the device driver based on the model dependent information; and
in response to determining that the device can be driven by the device driver, generating a user interface screen for the device driver using the model dependent information of the device.
